(19) United States
(12) Patent Application Publication
(10) Pub. No.: US 2008/0155044 A1
(43) Pub. Date: Jun. 26, 2008

(54) RECEPTION SYSTEM, METHOD OF RECEIVING INFORMATION AND PROGRAM

(75) Inventor: Fumiyoshi YOSHIDA, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NeoCSM Corporation, Chuo-ku (JP)

(21) Appl. No.: 11/962,849

(22) Filed: Dec. 21, 2007

(30) Foreign Application Priority Data
Dec. 25, 2006 (JP) 2006-347922

(51) Int. Cl. G06F 15/16

(52) U.S. Cl. 709/206

(57) ABSTRACT

A server device connected to a network comprises a data processing part that generates primary information by separating and extracting a topic and principal text contained in an e-mail from received information that has been received in the form of this e-mail from an external device. Each time the server device receives an e-mail, primary information is generated. Only the generated primary information is transmitted through a LAN to a browsing terminal device. This prohibits the transmission of an address contained in an e-mail to the browsing terminal device to thereby prohibit the display of an address as personal information on the browsing terminal device.

### BACKGROUND OF THE INVENTION

1. Field of the Invention

The present invention relates to a technique of protecting personal information contained in e-mails when various types of information are collected and viewed by using e-mails.

2. Description of the Background Art

As a result of widespread use of the Internet in recent years, e-mail service is readily available from user's terminal devices such as personal computers or portable phones. A reception system for receiving complaints or requests from users, or for providing consultation and the like by using e-mail service has conventionally been suggested.

Unlike a reception system by telephone, according to this reception system, information from users are collected in the form of electronic information, and thus information management is advantageously facilitated. This reception system is also favorably usable in that users are not required to prepare any particular structure.

However, according to the conventional reception system using e-mail service, the contents of an e-mail are displayed on a display and the like using browsing software that is a so-called mailer. This causes personal information contained in an e-mail (which is mainly an e-mail address) to be displayed, so an operator in charge of handling can easily know this personal information.

Unlike the e-mail service that is intended to provide one-to-one exchange with a particular person, an unspecified number of users are targeted for the service presented by the reception system. Thus the management of personal information is an important issue. Its importance has been increasingly growing in recent years, especially with the implementation of the Personal Information Protection Law.

### SUMMARY OF THE INVENTION

The present invention has been made in view of the above-discussed problem. The present invention provides a reception system and a program for preventing the leakage of personal information of a user having sent an e-mail by using e-mail service.

The present invention is intended for a reception system for collecting primary information by e-mail from an external terminal device through a network.

According to the present invention, this reception system comprises: a receiving element for receiving an e-mail sent from the external terminal device; a separation element for separating primary information and personal information from an e-mail received by the receiving element; and a display element for displaying primary information separated by the separation element. The display element is prohibited from displaying personal information separated by the separation element.

While widely and generally used e-mail service is applied, the leakage of personal information can be prevented.

The present invention is also intended for an information reception method for collecting primary information by e-mail from an external terminal device through a network.

According to the present invention, this information reception method comprises: (a) a step of receiving an e-mail sent from the external terminal device; (b) a step of separating primary information and personal information from an e-mail received in the step (a); and (c) a step of displaying primary information separated in the step (b) and prohibiting the display of personal information separated in the step (b).

While widely and generally used e-mail service is applied, the leakage of personal information can be prevented.

The present invention is also intended for a program readable by a computer connected to an external terminal device through a network

According to the present invention, the execution of the program by the computer causes the computer to function as a reception system that comprises: a receiving element for receiving an e-mail sent from the external terminal device; a separation element for separating primary information and personal information from an e-mail received by the receiving element; and a display element for displaying primary information separated by the separation element. This reception system prohibits the display element from displaying personal information separated by the separation element.

While widely and generally used e-mail service is applied, the leakage of personal information can be prevented.

According to one aspect of the present invention, the execution of the program by the computer causes the computer to function as a server device that comprises: a receiving element for receiving an e-mail sent from the external terminal device; a separation element for separating primary information and personal information from an e-mail received by the receiving element; and a transmission element for transmitting primary information separated by the separation element to a browsing terminal device, and for prohibiting the transmission of personal information separated by the separation element.

While widely and generally used e-mail service is applied, the leakage of personal information can be prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an exemplary configuration of a reception system according to the present invention;

FIG. 2 shows the configuration of a server device;

FIG. 3 shows functional blocks of the server device together with the flow of data;

FIG. 4 shows the configuration of a browsing terminal device;

FIG. 5 shows functional blocks of the browsing terminal device together with the flow of data;

FIG. 6 is a flow diagram showing the operation mainly of the server device of the reception system;

FIG. 7 is a flow diagram showing allocation process in detail;

FIG. 8 shows reporting process in detail;

FIG. 9 is a flow diagram showing the operation of the browsing terminal device; and

FIG. 10 shows an exemplary configuration of a reception system according to a second embodiment.

### DESCRIPTION OF THE PREFERRED EMBODIMENTS

In the following, preferred embodiments of the present invention are described in detail with reference to the accompanying drawings.

### 1. First Embodiment

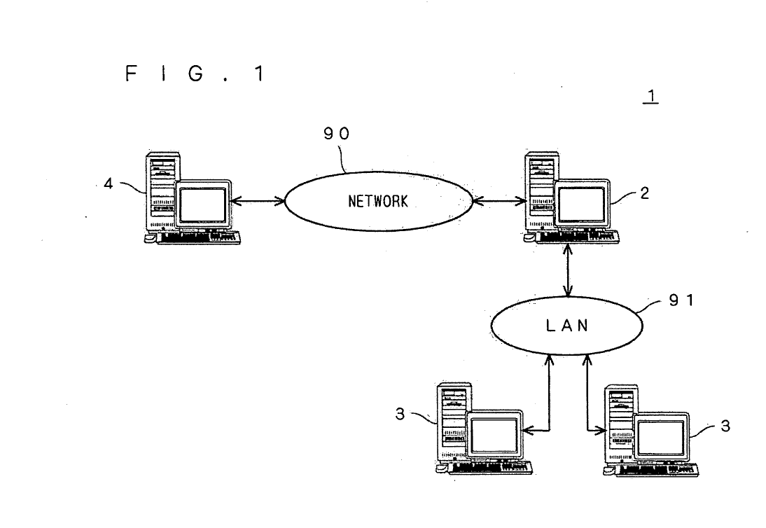

FIG. 1 shows an exemplary configuration of a reception system 1 according to the present invention. The reception system 1 includes a server device 2, a plurality of browsing terminal devices 3 and an external terminal device 4. The server device 2 and the external terminal device 4 are capable of sending and receiving e-mails to and from each other through a network 90. The server device 2 and each of the browsing terminal devices 3 are connected to each other in such a manner as to realize data communication therebetween through a LAN 91.

In the following, the reception system 1 of the present embodiment is described as a system in which claims (primary information which includes complaints, request, questions, consultations, suggestions and the like) from a user (external terminal device 4) are collected by e-mail, and an operator (browsing terminal device 3) suitably handles the collected primary information.

However, the use of the present invention is not limited to such a mode. The present invention is also applicable to a system that does not necessarily require operator's handling which, for example, a system in which questionnaires or votes are accepted by e-mail. That is, the present invention finds widespread application. In the description of the present embodiment, where appropriate, an administrator or the like of the reception system 1 is referred to as a system operator, and a person handling e-mails from users individually is referred to as an operator in charge.

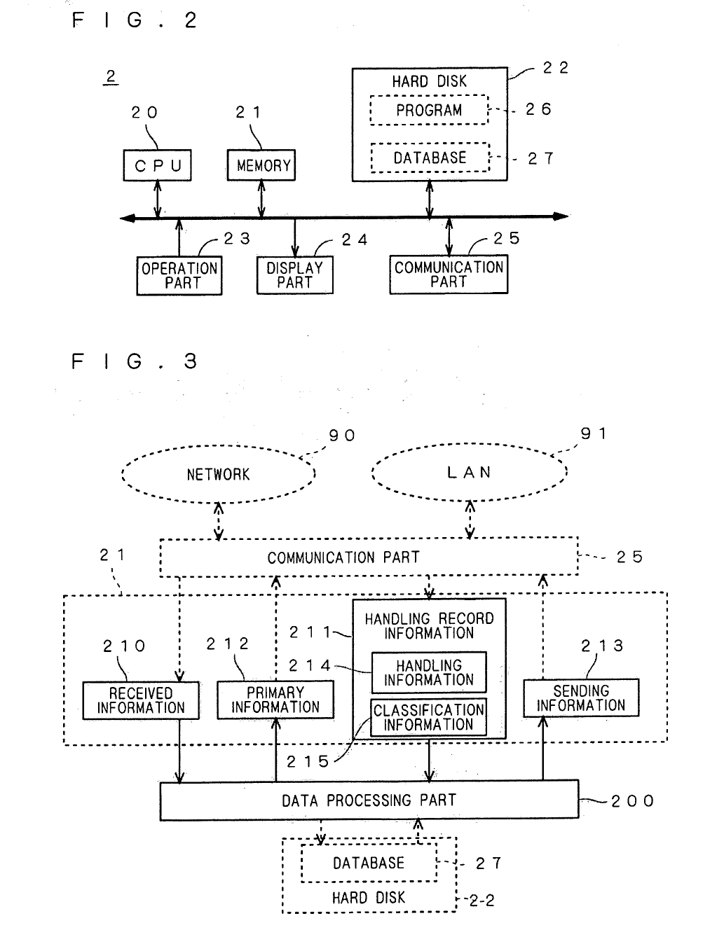

FIG. 2 shows the configuration of the server device 2. The server device 2 has a CPU 20, a memory 21, a hard disk 22, an operation part 23, a display part 24, and an communication part 25. The server device 2 has a function as a generally used computer.

The CPU 20 is brought into operation in accordance with a program 26 stored in the hard disk 22 to thereby perform operation of various types of data and generate control signals. As shown in FIG. 2, the CPU 20 is connected through a bus line to each one of the components of the server device 2, and controls these components based on the generated controls signals. The operation and function of the CPU 20 are discussed in detail below.

The memory 21 is formed by a RAM used as a temporary working area of the CPU 20, a read-only memory (ROM) and the like, and is operative to store various types of data. The hard disk 22 stores the program 26 and a database 27. Namely, the memory 21 and the hard disk 22 mainly correspond to a storage element of the present invention.

The operation part 23 is formed by a keyboard, a mouse, and several buttons not shown. The operation part 23 is operated mainly by a system operator, and is used to enter necessary instructive information into the server device 2 (reception system 1).

The display part 24 is formed by a liquid crystal display, an LED and the like. The display part 24 is operative to display various types of information, to mainly let the system operator know every condition.

The communication part 25 establishes connection of the server device 2 to the network 90, and of the server device 2 to the LAN 91. Namely, the communication part 25 mainly corresponds to a receiving element and a transmission element of the present invention.

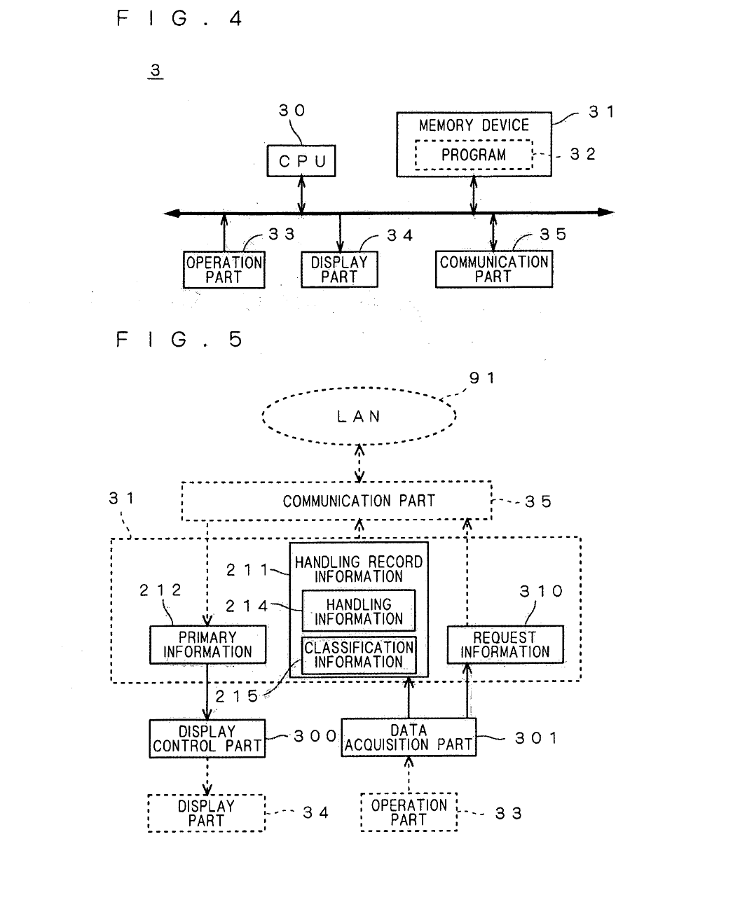

FIG. 3 shows functional blocks of the server device 2 together with the flow of data. A data processing part 200 shown in FIG. 3 corresponds to a functional block that is realized mainly by the operation of the CPU 20 in accordance with the program 26.

With reference to FIG. 3, the communication part 25 discussed above receives an e-mail from the external terminal device 4, and transmits the received e-mail as received information 210 to the memory 21. The communication part 25 also receives handling record information 211 from the browsing terminal devices 3, and transmits the received handling record information 211 to the memory 21. Further, the communication part 25 obtains primary information 212 from the memory 21, and transmits the obtained primary information 212 to the browsing terminal devices 3. The communication part 25 also obtains sending information 213 from the memory 21, and transmits the received sending information 213 as an e-mail to the external terminal device 4.

The received information 210 is such information that information contained in an received e-mail is linked in a certain format. The received information 210 is not necessarily required to include all the information contained in this e-mail. The received information 210 may be formed by thinning the information contained in this e-mail out in a form required in the reception system 1. The received information 210 in the present embodiment at least includes the topic (subject), principal text (body), and the address of a source (network address) of an e-mail.

The data processing part 200 causes the received information 210 to be stored in the database 27 of the hard disk 22. The received information 210 to be stored is given an identification number (such as a reception number) for identifying this received information 210. In other words, each time one e-mail is received, each record to be stored in the database 27 is automatically generated on the hard disk 22 by the data processing part 200. This record is formed by the received information 210, an identification number and additional information.

The additional information contains date and time of the receipt of an e-mail (date and time of record generation) as a source of the received information 210. When handling by an operator in charge has been completed, the additional information also contains information such as the identifier of the operator in charge, date and time of the handling, the handling record information 211 and the like. Thus, the handling record information 211 is stored in each record in the database 27, meaning that the received information 210, handling information 214 and classification information 215 are stored in a linked relationship.

The data processing part 200 searches the database 27 in response to the request by the browsing terminal device 3, and retrieves a record that has not been handled. Then, the data processing part 200 extracts information corresponding to a topic and information corresponding to principal text from the received information 210 contained in the retrieved record, adds the identification number of this received information 210 to the extracted information, and generates the primary information 212.

Then, only the primary information 212 is separated from an e-mail (received information 210) received by the communication part 25 (server device 2), so the primary information 212 is separated from the personal information such as an address that has originally been contained in this e-mail. Namely, the data processing part 200 corresponds to a separation element of the present invention.

At this time, the identifier of the browsing terminal device 3 that has made a request (corresponding to the identifier of an operator in charge) is stored as additional information in this record. The data processing part 200 also adds the retrieved additional information to the primary information 212 to be generated (to be discussed in detail below). The generated primary information 212 is transmitted by the data processing part 200 to the memory 21.

The data processing part 200 is also operative to store the handling recording information 211 into the database 27, and to generate the sending information 213 (to be discussed in detail below).

Turning back to FIG. 1, the browsing terminal devices 3 have functions of a generally used computer, and are connected to the LAN 91. Although two browsing terminal devices 3 are shown in FIG. 1, the number of the browsing terminal devices 3 are not limited to this. The reception system 1 is required to have at least one browsing terminal device 3.

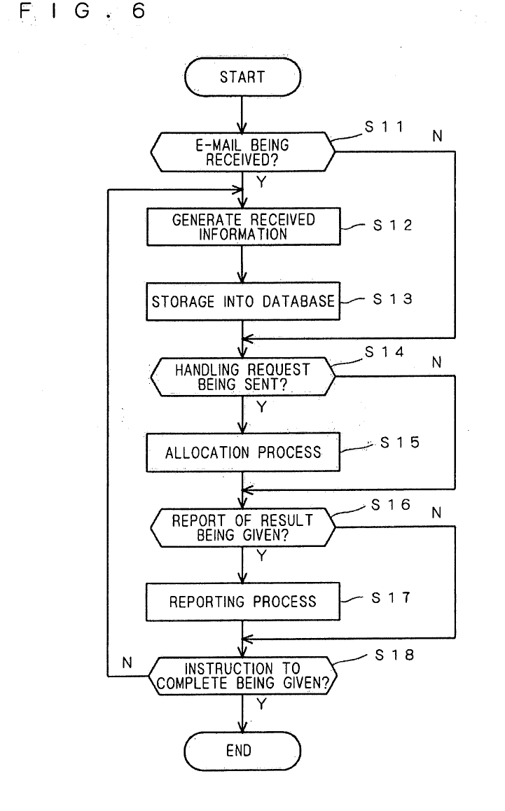

FIG. 4 shows the configuration of the browsing terminal device 3. The browsing terminal device 3 has a CPU 30, a memory device 31, an operation part 33, a display part 34, and a communication part 35.

The CPU 30 is brought into operation in accordance with a program 32 stored in the memory device 31 to thereby perform operation of various types of data and generate control signals. As shown in FIG. 4, the CPU 30 is connected through a bas line to each one of the components of the browsing terminal device 3, and controls these components based on the generated control signals.

The memory device 31 is formed by a RAM used as a temporary working area of the CPU 30, a read-only memory (ROM), a hard disk of a comparatively large capacity, and the like, and stores the program 32 and various types of data. The program 32 is software that is a so-called browser mainly for causing the primary information 212 to be displayed on the display part 34.

The operation part 33 is formed by a keyboard, a mouse, and several buttons not shown. The operation part 33 is operated mainly by an operator in charge, and is used to enter necessary instructive information into the browsing terminal device 3 (reception system 1). Instructive information for generating the handling record information 211 is especially entered from the operation part 33.

The display part 34 is formed by a liquid crystal display, an LED and the like. The display part 34 is operative to display various types of information, to mainly let the operator in charge know every condition. The primary information 212 is especially displayed on the display part 34. Namely, the display part 34 mainly corresponds to a display element of the present invention.

The communication part 3 connects the browsing terminal device 3 to the LAN 91 to thereby realize data communication between the browsing terminal device 3 and the server device 2. Then, the browsing terminal device 3 receives the primary information 212 from the server device 2, and sends request information 310 (FIG. 5) for requesting the transmission of the primary information 212, and the handling record information 211 to the server device 2.

FIG. 5 shows functional blocks of the browsing terminal device 3 together with the flow of data. A display control part 300 and a data acquisition part 301 shown in FIG. 5 correspond to functional blocks that are realized mainly by the operation of the CPU 30 in accordance with the program 32.

The display control part 300 is operative to cause the primary information 212 sent from the server device 2 to be displayed on the display part 34. The data acquisition part 301 generates the request information 310 and the handling record information 211 based on the instructive information given from the operation part 33.

That is, a display screen of the browser is provided by the display control part 300. The instructive information that is entered by an operator in charge based on this display screen is caused by the data acquisition part 301 to function as the request information 310 and the handling record information 311.

In the description of the present embodiment, the server device 2 and each of the browsing terminal devices 3 are connected through the LAN 91. Alternatively, the server device 2 and each of the browsing terminal devices 3 may be independently connected by specific cables and the like. Still alternatively, the browsing terminal devices 3 may be connected to the network 90 to realize data communication between the browsing terminal devices 3 and the server device 2. That is, as long as data communication is realized between the server device 2 and each of the browsing terminal devices 3, connection therebetween may be made arbitrarily.

Turning buck to FIG. 1, the external terminal device 4 is a device on which general e-mail service is available, and is used by a user. A user operates the external germinal device 4 to create an e-mail, and sends the same to the server device 2, thereby transmitting information to the reception system 1.

Then, the collection of information is realized by the use of e-mail service whereby the reception system 1 is capable of providing general users with service that does not require any particular device or software. Namely, a system of a high level of convenience can be provided.

Although only one external terminal device 4 is shown in FIG. 1, the number of the external terminal device 4 is not limited to one. The external terminal device 4 may be a portable communication terminal device such as a portable phone. That is, as long as the transmission and receipt of e-mails are realized through the network 90, the external terminal device 4 may be an arbitrary device.

The configuration and function of the reception system 1 are as described above. The operation of the reception system 1 is described below.

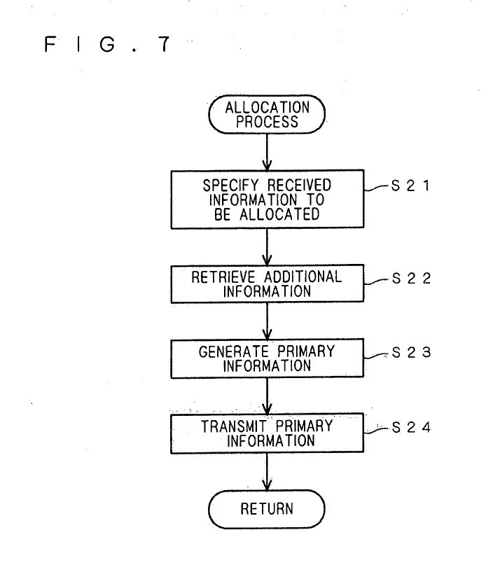

FIG. 6 is a flow diagram showing the operation mainly of the server device 2 of the reception system 1. After the server device 2 is turned on, the server device 2 executes prescribed default settings and thereafter moves to a monitor state.

In the monitor state, the server device 2 checks to see if an e-mail has been received from the external terminal device 4 (step S11), if a handling request has been sent from the browsing terminal device 3 (step S14), if a report of result has been given from the browsing terminal device 3 (step S16), and if an instruction to complete has been received from a system operator (step S18).

In the monitor state, the result of step S11 is Yes if the server device 2 (communication part 25) receives an e-mail. Then, the communication part 25 generates the received information 210 (step S12), and transmits the same to the memory 21. Next, the data processing part 200 gives an identification number to the generated received information 210, and stores the same into the database 27 (step S13) whereby the received information 210 is registered on the database 27.

In the monitor state, when the server device 2 (communication part 25) receives the request information 310, the CPU 20 determines that a handling request has been given from the browsing terminal device 3. Then the result of step S14 is Yes and allocation process is executed (step S15).

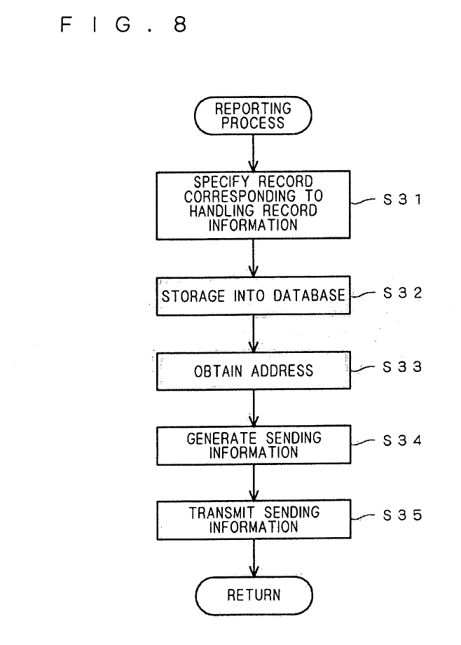

FIG. 7 is a flow diagram showing the allocation process in detail. First, in the allocation process, the received information 210 is specified which is to be allocated to the browsing terminal device 3 having sent the request information 310 (step S21). This is realized by the search of the database 27 by the data processing part 200 to specify the received information 210 that has not been handled.

As an example, a record with no identifier of the browsing terminal device 3 in additional information is retrieved to specify the received information 210 stored in this record, thereby specifying the received information 210 that has not been handled. When several pieces of received information 210 yet to be handled are present, the received information 210 is specified and allocated in the order of date and time of reception (date and time of receipt), for example. The date processing part 200 also incorporates the identifier of the browsing terminal device 3 (or the identifier of an operator in charge) to which the received information 210 is allocated into additional information associated with the specified received information 210.

Next, the data processing part 200 obtains a mail address from the received information 210 specified in step S21, and performs search of the database 27 using the obtained mail address as a search key. Then, a record storing the same mail address is specified to retrieve additional information stored in this record (step S22).

As discussed, the additional information of a record that has already been handled contains the handling record information 211. Hence this step corresponds to a process of searching past history information of the source to which the allocated received information 210 has been sent. Thus, by the extraction of additional information related to the same mail address by the data processing part 200, the reception system 1 is allowed to automatically obtain past history information of the same source of inquiries.

Next, based on the received information 210 specified in step S21, the identification number of this received information 210, and the additional information (history information) retrieved in step S22, the data processing part 200 generates the primary information 212 (step S23). After the primary information 212 is generated, the communication part 25 transmits the primary information 212 to the browsing terminal device 3 that has sent the request information 310 (step S24).

As discussed, the primary information 212 transmitted to the browsing terminal device 3 does not contain the mail address of the external terminal device 4. That is, in the reception system 1, the server device 2 disables the transmission of a mail address as personal information of a user to the browsing terminal device 3, so the browsing terminal device 3 is not allowed to obtain, and to naturally display this mail address. As a result, the leakage of personal information of a user is prevented. The prohibition of the acquisition of personal information by the browsing terminal device 3 especially results in the prevention of the diffusion of personal information. Thus, as compared to the case of simply prohibiting display, the diffusion of personal information is effectively prevented.

After the primary information 212 is sent to the browsing terminal device 3 in response to the request information 310 given from this browsing terminal device 3, the server device 2 completes the allocation process and returns to the monitor state.

Turning back to FIG. 6, when the server device 2 (communication part 25) receives the handling record information 211 in the monitor state, the CPU 20 determines that a report of result has been given from the browsing terminal device 3. Then the result of step S16 is Yes and reporting process is executed (step S17).

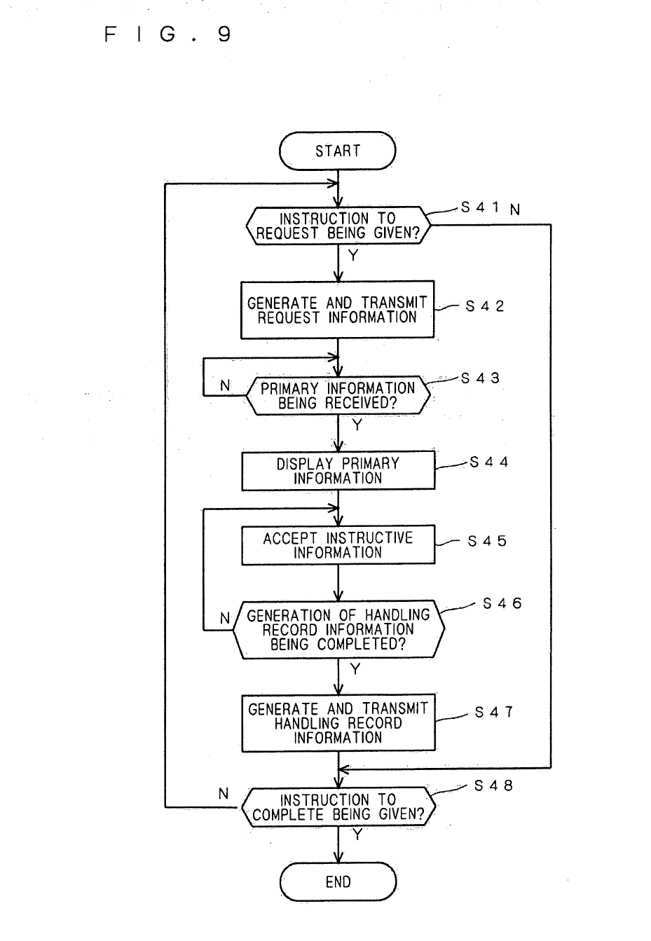

FIG. 8 shows the reporting process in detail. First, in the reporting process, a record is specified from the database 27 that corresponds to the handling record information 211 received by the data processing part 200 (step S31). As discussed in detail later, the handling record information 211 contains an identification number. Then, using this identification number as a search key, the data processing part 200 performs search of the database 27 to thereby specify a corresponding record.

After the record is specified, the data processing part 200 stores the handling record information 211 into this record whereby the handling record information 211 is stored in the database 27 (step S32).

Next, from the received information 210 stored in the record specified in step S31, the data processing part 200 obtains the address of the source of this received information 210 (e-mail) (step S33). Based on the obtained address of the source, the address of the server device 2, and the handling information 214 contained in the handling record information 211, the data processing part 200 generates the sending information 213 (step S34).

After the sending information 213 is generated, the communication part 25 makes reference to the address contained in the sending information 213, and transmits an e-mail formed from the sending information 213 to the external terminal device 4 (step S35).

As discussed, when the handling record information 211 is received, the server device 2 automatically generates and transmits a reporting e-mail. Thus, even a system operator is allowed to operate the system without concern for addresses of individual users. That is, there is no need to disclose personal information even to a system operator to thereby prevent the leakage of personal information.

A user who has made an inquiry and the like by using an e-mail from the external terminal device 4 is allowed to receive a report and the like from an operator in charge in response to this inquiry in the form of an e-mail (handling information 214) sent from the reception system 1. Then, the reception system 1 realizes bidirectional information exchange between a user and an operator in charge by using e-mails.

After the communication part 25 sends an e-mail to the external terminal device 4, the server device 2 completes the reporting process and returns to the monitor state.

Turning back to FIG. 6, when a system operator operates the operation part 23 to enter an instruction to complete in the monitor state, the server device 2 determines that the result of step S18 is Yes and completes all processes.

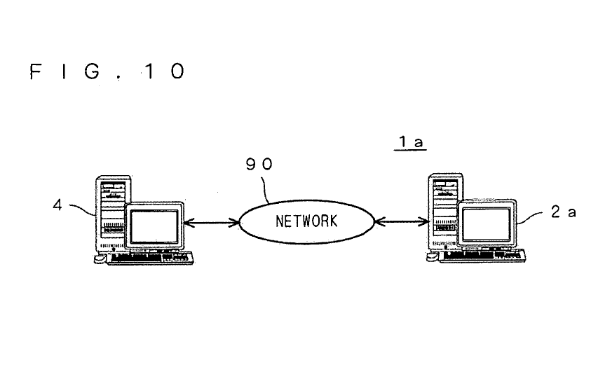

FIG. 9 is a flow diagram showing the operation of the browsing terminal device 3. After the browsing terminal device 3 is turned on, the browsing terminal device 3 executes prescribed default settings and thereafter moves to a monitor state. In the monitor state, a browser provided by the program 32 is running on the browsing terminal device 3.

In the monitor state, the browsing terminal device 3 monitors an instruction to request and an instruction to complete given from an operator in charge (steps S41, S48).

In the monitor state, when the operator in charge operates the operation part 33 to enter an instruction to request, the data acquisition part 301 generates the request information 310. The communication part 35 transmits the generated request information 310 to the server device 2 (step S42).

This causes a handling request to be given from this browsing terminal device 3 to the server device 2. At this time, the data acquisition part 301 incorporates the identifier of the browsing terminal device 3, the identifier of the operator in charge who operates this browsing terminal device 3 and the like into the request information 310.

After the request information 310 is sent, the browsing terminal device 3 stands by until the primary information 212 is given from the server device 2 (step S43).

After the primary information 212 is received, the display control part 300 causes the received primary information 212 to be displayed on the display part 34 (step S44). As discussed above, the primary information 212 contains the topic, principal text, date and time of the receipt, and history information of an e-mail received by the server device 2. Then, the operator in charge sees the screen displayed on the display part 34, and operates the operation part 33 while examining these types of information to thereby make suitable handling.

The address of the source of this e-mail is not contained, so the display of personal information on the display part 34 is effectively prohibited. Then the leakage of the address as personal information to the operator in charge is prevented.

While receiving instructive information entered by the operator in charge through the operation part 33 (step S45), the browsing terminal device 3 stands by until instructive information to finish the generation of the handling record information 211 is entered (step S46).

When the instructive information is entered which gives an instruction to finish the generation of the handling record information 211 that is responsive to the displayed primary information 212, the data acquisition part 301 generates the handling record information 211 based on the instructive information received at step S45. Then, the communication part 35 transmits the generated handling record information 211 to the server device 2 (step S47).

At step S47, the data acquisition part 301 generates the handling information 214 based on the information indicative of the contents of handling made by the operator in charge (such as a reply to a question), and the classification information 215 based on the information indicative of category classification in response to an inquiry and the like from a user. Further, the data acquisition part 301 establishes a link between the generated handling information 214 and the classification information, and the identification number contained in the primary information 212 to thereby generate the handling record information 211.

The data acquisition part 301 sees to which entry field of the browser displayed on the screen the instructive information was given, to thereby make a distinction of whether the instructive information entered by the operator in charge is the handling information 214 or the classification information 215.

Information contained in the classification information 215 is used to classify the primary information 212. More specifically, this information relates to the model number of a product targeted for an inquiry, the function, incident (such as malfunction or insufficient packaging) and the like of the product, and is used in the reception system 1. As discussed above, the handling information 214 is sent mainly to a user.

In the reception system 1, the classification information 215 is thereby entered and generated by the operator in charge. As discussed above, this classification information 215 is stored in the database 27 of the server device 2 as the handling record information 211. Thus, information collected by e-mail (primary information 212) can be easily classified and searched in the database 27 to thereby improve the convenience of the database 27.

More specifically, only inquires related to the password of a product may be extracted, or it may be considered to which product a large number of inquires are directed. Or, inquires actually made by operators in charge may be studied on a per-operator basis to select an expert in each inquiry. These may be possible methods of utilization (business models) thereof.

When the operator in charge enters an instruction to complete in the monitor state, the browsing terminal device 3 determines that the result of step S48 is Yes and completes all processes.

As described above, the reception system 1 according to the first embodiment is configured as a system for collecting the primary information 212 by e-mail that are given through the network 90 from the external terminal device 4. The data processing part 200 separates the primary information 212 and a mail address (personal information) from the e-mail received by the communication part 25, and transmits the separated primary information 212 to the browsing terminal device 3. The display part 34 of the browsing terminal device 3 displays the primary information 212, so personal information is prevented from being displayed on the display part 34. As a result, while widely and generally used e-mail service is applied, the leakage of personal information can be prevented.

The server device 2 connected to the network 90 and the browsing terminal devices 3 capable of realizing data communication with the server device 2 are provided so that a device for receiving e-mails and a device for displaying the e-mails are configured as different devices. This more reliably prevents the leakage of personal information.

Further, the handling information 214 responsive to the primary information 212 is accepted as an input made by an operator, and the handling information 214 is transmitted to the external terminal device 4 that has sent an e-mail. Thus the operator is allowed to send the handling information 214 without concern for a destination. That is, in the reception system 1, the operator can make a report without being provided with an address as personal information.

Still further, the classification information 215 responsive to the primary information 212 as well as the handling information 214 responsive to the primary information 212 are accepted to store the primary information 212, the handling information 214 and the classification information 215 in a linked relationship. As a result, the primary information 212 and the handling information 214 can be classified and searched by using the classification information 215.

### 2. Second Embodiment

In the reception system 1 according to the first embodiment, the server device 2 and the browsing terminal devices 3 are configured as different devices. The applicability of the present invention is not limited to this embodiment.

FIG. 10 shows an exemplary configuration of a reception system 1a according to a second embodiment that is made on the basis of this principle. In the reception system 1a, a server device 2a is connected to the network 90. The second embodiment is different from the first embodiment in that there is no structure corresponding to the browsing terminal devices 3 of the reception system 1.

The server device 2a has a configuration substantially the same as that of the server device 2. Thus in the following, the server device 2a is described with reference to FIG. 2.

The primary information 212 generated by the data processing part 200 of the reception system 1a is displayed directly on the display part 24 without being transmitted to the outside. That is, the display part 24 of the server device 2a is operative to function as the display part 34 of the browsing terminal device 3 in the first embodiment.

Like the primary information 212 generated in the first embodiment, primary information 212 generated by the reception system 1a of the second embodiment does not contain an address (personal information). Thus the leakage of personal information to an operator is prohibited.

An operator operates the operation part 23 based on a display screen presented at this time to enter instructive information whereby the handling record information 211 is generated. That is, the operation part 23 of the server device 2a is operative to function as the operation part 33 of the browsing terminal device 3 in the first embodiment.

Further, based on the generated handling record information, processes such as storage into the database 27, generation of the sending information 213 and transmission of e-mails are performed.

As seen from the description of the reception system 1a of the second embodiment given above, the provision of only the server device 2a realizes the same effect as achieved by the reception system 1 of the first embodiment.

### 3. Modifications

The embodiments of the present invention are as discussed above. The applicability of the present invention is not limited to the above-described embodiments. Various modifications of the present invention are possible.

As an example, the details, orders and the like of the respective steps described in the above embodiments are not limited to those shown in FIGS. 6 through 9. Namely, the details and orders may be suitably changed as long as the same effect is achieved.

The functional blocks shown in the above embodiments are described as being realized by software. Part or all of these functional blocks may be realized as hardware by the use of a dedicated logic circuit.

The function of the server device 2 may be realized by a plurality of devices. That is, a mail server device for receiving e-mails and transmitting the primary information 212 to the browsing terminal devices 3, and a database server device for storing the database 27 may be provided.

The network 90 may be of an arbitrary form, as long as the network 90 is capable of providing commonly used e-mail service. By way of example, the network 90 may be a LAN, a public telephone network, the Internet, a radio communication network, a packet communication network or the like, or may be a mixture therefrom.

In the embodiments described above, information corresponding to a topic (subject) and information corresponding to principal text (body) are extracted and contained in the primary information 212. However, both of these information are not necessarily required. Only one of these information may be contained in the primary information 212. As an example, in the case of an e-mail where only information corresponding to a topic is significant and no information corresponding to principal text is given (such e-mail is a so-called “blank mail”), only the topic of these information may be contained in the primary information 212. Or, in the case where information corresponding to a topic is “untitled e-mail” and only information corresponding to principal text is significant, only the principal text of these information may be contained in the primary information 212.

The program 32 described in the first embodiment (browser software) may be commonly used mailer software. In this case, the server device 2 transmits the primary information 212 in the form of an e-mail to the browsing terminal device 3. Then, the address of the server device 2 is displayed a source of the e-mail on the display part 34 of the browsing terminal device 3. This effectively prohibits the display of personal information of a user. As a result, while cost reduction required for system configuration is realized by the use of generally distributed software, the leakage of personal information is prevented.

While the invention has been shown and described in detail, the foregoing description is in all aspects illustrative and not restrictive. It is therefore understood that numerous modifications and variations can be devised without departing from the scope of the invention. The scope of the present invention is shown by claims.

What is claimed is:

1. A reception system for collecting primary information by e-mail from an external terminal device through a network, comprising:
a receiving element for receiving an e-mail sent from said external terminal device;
a separation element for separating primary information and personal information from an e-mail received by said receiving element; and
a display element for displaying primary information separated by said separation element,
said display element being prohibited from displaying personal information separated by said separation element.

2. The reception system according to claim 1, wherein
said receiving element and said separation element are arranged in a server device connected to said network,
said display element is arranged in a browsing terminal device connected to said server device in such a manner as to realize data communication between said browsing terminal device and said server device, and
said server device transmits primary information separated by said separation element to said browsing terminal device, and prohibits the transmission of personal information separated by said separation element.

3. The reception system according to claim 1, further comprising:
an operation element operated by an operator to receive handling information that is responsive to primary information; and
a transmission element for transmitting said handling information to an external terminal device that has sent an e-mail on the basis of personal information separated from said e-mail that contains said primary information.

4. The reception system according to claim 3, wherein
said operation element accepts classification information responsive to primary information as well as handling information responsive to said primary information,
the reception system further comprising:
a storage element for storing said primary information, handling information and classification information accepted by said operation element in a linked relationship.

5. An information reception method for collecting primary information by e-mail from an external terminal device through a network, comprising the steps of:
(a) receiving an e-mail sent from said external terminal device;
(b) separating primary information and personal information from an e-mail received in said step (a); and
(c) displaying primary information separated in said step (b) and prohibiting the display of personal information separated in said step (b).

6. A program readable by a computer connected to an external terminal device through a network, the execution of said program by said computer causing said computer to function as a reception system that comprises:
a receiving element for receiving an e-mail sent from said external terminal device;
a separation element for separating primary information and personal information from an e-mail received by said receiving element; and
a display element for displaying primary information separated by said separation element,
said reception system prohibiting said display element from displaying personal information separated by said separation element.

7. A program readable by a computer connected to an external terminal device through a network, the execution of said program by said computer causing said computer to function as a server device that comprises:
a receiving element for receiving an e-mail sent from said external terminal device;
a separation element for separating primary information and personal information from an e-mail received by said receiving element; and
a transmission element for transmitting primary information separated by said separation element to a browsing terminal device, and for prohibiting the transmission of personal information separated by said separation element.
